(19) United States
(12) Patent Application Publication
(10) Pub. No.: US 2025/0383749 A1
(43) Pub. Date: Dec. 18, 2025

(54) SWITCH BETWEEN MULTIPLE SCREENS BY DETECTING CURSOR MOVEMENT

(71) Applicant: Citrix Systems, Inc., FT. LAUDERDALE, FL (US)

(72) Inventors: Jia Yin, Nanjing (CN); Chuchu Ye, Nanjing (CN); Zongpeng Qiao, Nanjing (CN); Ke Xu, Nanjing (CN)

(21) Appl. No.: 18/867,518

(22) PCT Filed: Sep. 19, 2022
(86) PCT No.: PCT/CN2022/119534

§ 371 Date: Dec. 3, 2024

(51) Int. Cl. G06F 3/04812; G06F 3/0482

(52) U.S. Cl. CPC G06F 3/04812; G06F 3/0482

(57) ABSTRACT

A computing system includes a client computing device and a cloud management platform. The client computing device includes a plurality of screens, with each screen having at least one session displayed therein. Each session has a boundary area associated therewith. A cursor monitor agent within the client computing device monitors movement of the cursor in the boundary area of the session having the cursor therein. The cloud management platform includes a cursor analysis service to analyze movement of the cursor within the boundary area to determine if a movement parameter is met indicating that a user intends to switch to a different session. The cursor monitor agent displays an options menu within the session having the cursor therein in response to the movement parameter having been met. The options menu provides options for the user to switch to the different session.

### RELATED APPLICATIONS

This application claims the benefit of and is a National Stage Filing under 35 U.S.C. § 371 of International Patent Cooperation Treaty (“PCT”) Application No. PCT/CN2022/119534 (filed Sep. 19, 2022), which is incorporated here by reference in its entirety.

### TECHNICAL FIELD

The present disclosure relates to computing systems, and more particularly, to computing system that detects cursor movement in a multi-screen environment to assist a user in switching screens.

### BACKGROUND

Many organizations are now using application and/or desktop virtualization to provide a more flexible option to address the varying needs of their users. In desktop virtualization, a user's operating system, applications, and/or user settings may be separated from the user's physical smartphone, laptop, or desktop computer.

Using client-server technology, a virtualized desktop may be stored in and administered by a remote server, rather than in the local storage of a computing device. The computing device accesses the virtualized desktop in a remote computing session with the server. The remote computing session allows a user to access resources. The resources, for example, include SaaS and web apps, desktops, files and data. At times, the resources may be displayed on multiple screens to increase the area available for the programs and applications running on a single computing device.

### SUMMARY

A computing system includes a client computing device and a cloud management platform to be accessed by the client computing device. The client computing device includes a plurality of screens, with each screen having at least one session displayed therein. Each session has a boundary area associated therewith. A processor is coupled to the plurality of screens, and an input device is coupled to the processor and configured to control movement of a cursor on the plurality of screens. A cursor monitor agent is executed by the processor to monitor movement of the cursor in the boundary area of the session having the cursor therein.

The cloud management platform includes a cursor analysis service in communications with the cursor monitor agent. The cursor analysis service is configured to analyze movement of the cursor within the boundary area to determine if a movement parameter is met indicating that a user intends to switch to a different session. The cursor monitor agent is configured to display an options menu within the session having the cursor therein in response to the movement parameter having been met. The options menu provides options for the user to switch to the different session.

The options menu may provide a list of the other sessions the user could switch to, with selection of the session being made using the input device.

In response to the user selecting the session to switch to, the cursor monitor agent may be configured to move the cursor to the selected session.

The cursor monitor agent may be configured to move the cursor to the selected session based on fetching a layout of the screen having the selected session, and position of the selected session within the screen. Origin coordinates of the selected session being switched to are identified, and a function command is executed to position the cursor at a center of the selected session.

The cursor monitor agent may be further configured to stop display of the options menu in response to the user not selecting one of the displayed options within a set time period.

For the options menu to reappear, the cursor may be moved out of the boundary area and then moved back into the boundary area, and the cursor analysis service analyzes movement of the cursor within the boundary area to determine that the movement parameter has been met.

The options menu may provide a show tool bar option, and wherein the cursor monitor agent may be further configured to display a tool bar in response to the user selecting the tool bar option using the input device.

The cursor analysis service may be configured to determine one of the movement parameters based on determining a drop in velocity of the cursor while the cursor is still in the boundary area.

The cursor analysis service may be configured to determine one of the movement parameters based on determining continuous movement of the cursor within the boundary area for a set time interval without any buttons being pressed on the input device.

The cloud management platform may include a boundary area profile database, and wherein in response to the sessions being launched, the cursor monitor agent fetches the boundary area profiles corresponding to the launched sessions.

Another aspect is directed to a client computing device as described above. The client computing device includes a plurality of screens, with each screen having at least one session displayed therein. Each session has a boundary area associated therewith. A processor is coupled to the plurality of screens, and an input device is coupled to the processor to control movement of a cursor on the plurality of screens.

A cursor monitor agent is executed by the processor to monitor movement of the cursor in the session having the cursor therein, and to provide data on movement of the cursor within the boundary area to a cursor analysis service. The cursor analysis service determines if a movement parameter has been met indicating that a user intends to switch to a different session. An options menu is displayed within the session having the cursor therein in response to the movement parameter having been met. The options menu provides options for the user to switch to the different session.

Yet another aspect is directed to a method for operating the client computing device as described above. The method includes displaying a plurality of sessions on a plurality of screens, with each screen having at least one session displayed therein. Each session has a boundary area associated therewith.

The method includes monitoring movement of the cursor in the session having the cursor therein using a cursor monitor agent, and providing data on movement of the cursor within the boundary area to a cursor analysis service. The cursor analysis service determines if a movement parameter has been met indicating that a user intends to switch to a different session. The method further includes displaying an options menu within the session having the cursor therein in response to the movement parameter having been met. The options menu provides options for the user to switch to the different session.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computing system that detects cursor movement in a multi-screen environment to assist a user in switching screens according to aspects of the disclosure.

FIG. 7 is a schematic block diagram of the multi-screen setup in FIG. 6 with the sessions operating in a windows mode instead of a full screen mode.

FIG. 8 is a sequence flow diagram on operation of the computing system in FIG. 6.

FIG. 9 is a screenshot of the workspace user interface (UI) for the client computing device in FIG. 6, with the workspace UI allowing the user to define the boundary area profiles.

FIG. 10 is a graph on cursor movement within one of the sessions displayed in FIG. 6.

FIG. 11 is a flow diagram on operating the computing system in FIG. 6.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete.

Like numbers refer to like elements throughout, and prime notation is used to indicate similar elements in different embodiments.

The present description will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

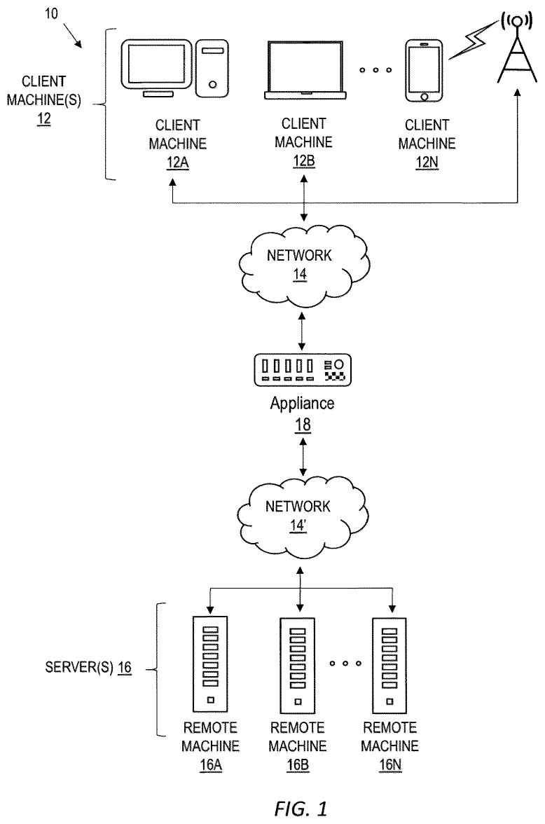

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′. In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 18 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

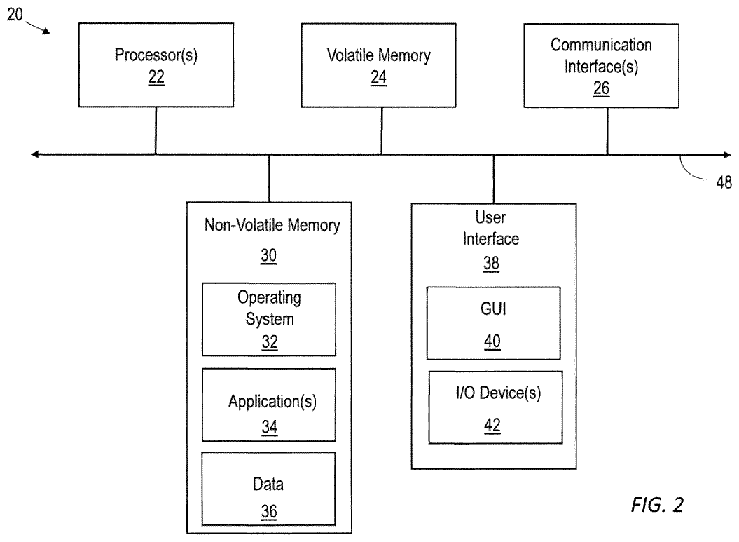

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Florida (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

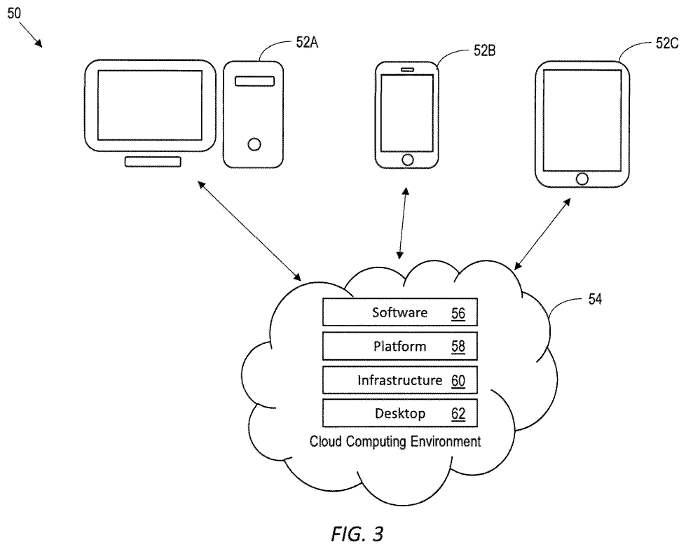

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft ONEDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

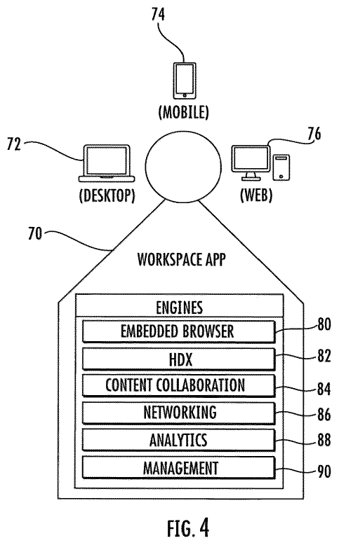

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific p-VPN connection. A p-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

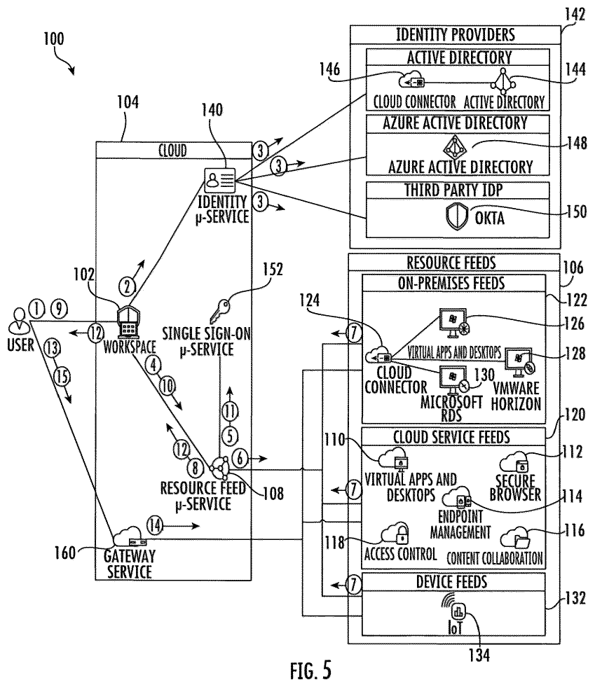

Referring now to FIG. 5, a workspace network environment 100 providing a unified experience to a user based on the workspace app 70 will be discussed. The desktop, mobile and web versions of the workspace app 70 all communicate with the workspace experience service 102 running within the Citrix Cloud 104. The workspace experience service 102 then pulls in all the different resource feeds via a resource feed micro-service 108. That is, all the different resources from other services running in the Citrix Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Citrix Cloud 104, and presenting their identity (event 1). The identity includes a user name and password, for example.

The workspace experience service 102 forwards the user's identity to an identity micro-service 140 within the Citrix Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Citrix Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

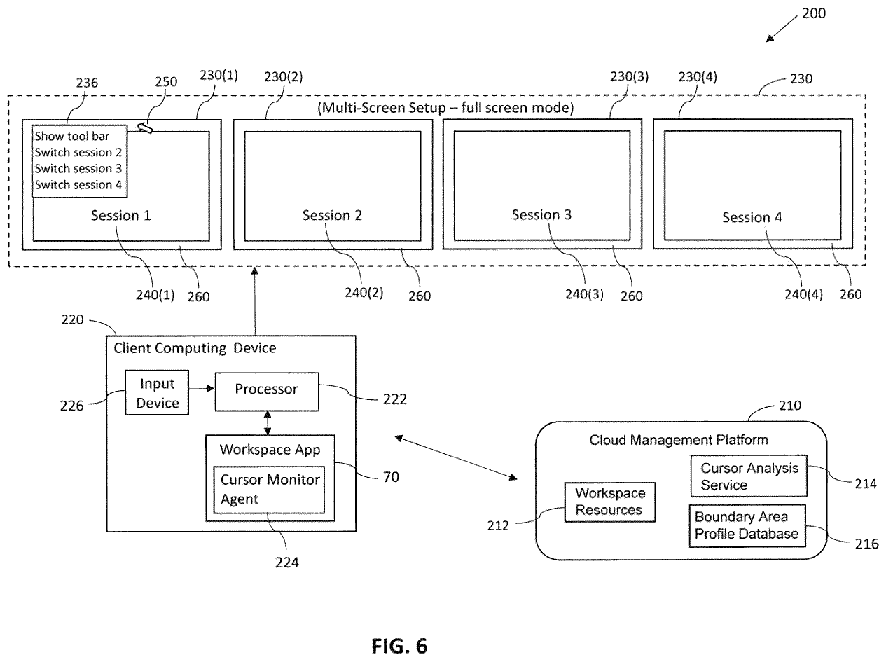

Referring now to FIG. 6, a computing system 200 configured to detect and analyze cursor 250 movement in a multi-screen setup 230 to assist a user in switching screens will be discussed. The computing system 200 includes a cloud management platform 210 to provide workspace resources 212, and a client computing device 220 in communications with the cloud management platform 210 to access the workspace resources 212.

The cloud management platform 210 may be Citrix Cloud, for example. Even though only one client computing device 220 is shown, the client computing device 220 is operating within an organization or enterprise along with other client computing devices.

The client computing device 220 operates multiple screens in the multi-screen setup 230. The actual number of screens will vary, which may be based on a user's preference.

The multi-screen setup 230 includes screen 1 230(1), screen 2 230(2), screen 3 230(3), and screen 4 230(4).

The multi-screen setup 230 allows the user to increase the area available to display the workspace resources 212 being accessed. Each workspace resource 212 being accessed may be displayed as a session on one of the screens.

In one embodiment of the multi-screen setup 230, each of the sessions may operate in a full screen mode, with a single session being displayed in each screen. Running a session in a full screen mode provides the largest screen area that is available for the session. Session 1 240(1) is displayed on screen 1 230(1), session 2 240(2) is displayed on screen 2 230(2), session 3 240(3) is displayed on screen 3 230(3) and session 4 240(4) is displayed on screen 4 230(4).

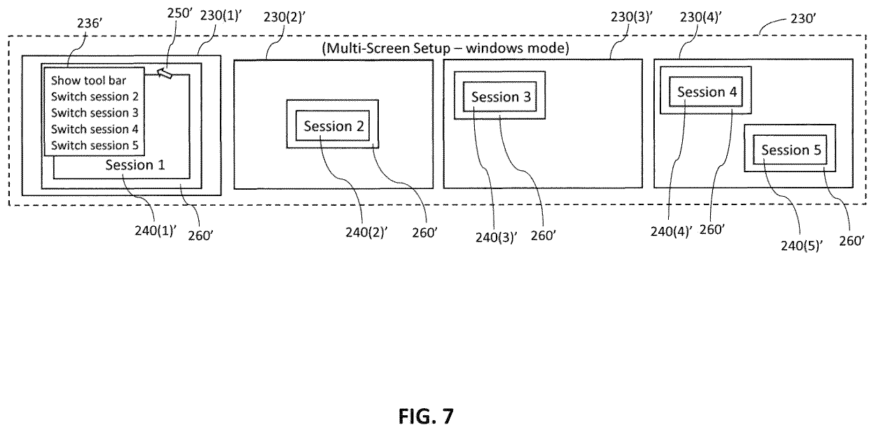

In another embodiment of the multi-screen setup 230′, the sessions may operate in a windows mode, as shown in FIG. 7. In the windows mode, each session occupies a portion of the available screen area. This allows more than one session to be displayed on a screen. Screen 4 230(4)′, for example, includes session 4 240(4)′ and session 5 240(5)′.

Currently, for a user to switch sessions in the multi-screen setup 230, the cursor 250 is moved to the session in the desired screen. To switch between screen 1 230(1) and screen 4 230(4), for example, the cursor 250 is moved across intervening screens 2 230(2) and 3 230(3). This requires the user to monitor movement of the cursor 250 across the intervening screens until the cursor 250 is positioned within screen 4 230(4). The same procedures are needed for a user to switch sessions in the multi-screen setup 230′.

As the number of intervening screens increases, the time it takes to switch screens likewise increases. This negatively affects a user's experience of operating in the multi-screen setup 230, 230′. Consequently, there is a need to switch between screens in the multi-screen setup 230, 230′ without requiring the user to move the cursor 250, 250′ across intervening screens. For discussion purposes, the multi-screen setup 230 operating in the full screen mode will be used to show how this is provided. The same discussion may be equally applied to the multi-screen setup 230′ operating in the windows mode.

As will be explained in greater detail below, movement of the cursor 250 is monitored when in a boundary area 260 of one of the sessions. The boundary area 260 may also be referred to as a sensitive area. Cursor movement within the boundary area 260 is then analyzed to determine if a movement parameter is met indicating that a user intends to switch to a different session.

One of the movement parameters is based on velocity of the cursor 250 within the boundary area 260. The velocity of the cursor 250 may have a drop and the cursor 250 is still in the boundary area 260. Another parameter is based on continuous movement of the cursor 250 within the boundary area 260, where the user does not click or press any buttons on an input device 226 for a set time interval. The set time interval may be 2 to 3 seconds, for example.

In response to one of the movement parameters being met, the client computing device 220 displays an options menu 236 within the session having the cursor 250. The options menu 236 provides a show tool bar option, and a list of the other sessions that the user could switch to. When the cursor is in session 1 240(1), the user has the option to switch to session 2 240(2), session 3 240(3) or session 4 240(4). For the user to switch sessions, the cursor 250 is positioned over the desired session and then selected via a button on the input device 226.

If the user selects show tool bar, then a tool bar is shown. The tool bar allows the user to move, size, minimize, maximize or close the session. The tool bar is the same tool bar that is already available within a session. In this case, the tool bar is displayed when the cursor 250 is at the top edge of the session and the user selects a button on the input device 226.

When the options menu 236 is displayed, the user has a set time interval to make a selection. The set time interval may be 10 seconds, for example. If the user does not make a selection from the options menu 236 within the set time interval, then the options menu 236 disappears. For the options menu 236 to reappear, the user would have to move the cursor 250 out of the boundary area 260 and then move the cursor 250 back into the boundary area 260 while meeting one of the movement parameters.

Still referring to FIG. 6, the client computing device 220 includes a processor 224 coupled to the multi-screen setup 230, and a workspace app 70 executed by the processor 224. As discussed above, the workspace app 70 is how a user gets access to their workspace resources 212 within an organization, which includes applications and desktops, for example.

The workspace app 70 includes a cursor monitor agent 224 that is configured to monitor movement of the cursor 250 in the boundary area 260 of the session having the cursor therein. The input device 226 is coupled to the processor 222 to control movement of the cursor 250. The input device 226 may be a mouse or a touchpad, for example.

The cloud management platform 210 includes a cursor analysis service 214 and a boundary area profile database 216. The cursor analysis service 214 analyzes movement of the cursor 250 within the boundary area. The boundary area profile database 216 includes profiles of the boundary areas for each of the sessions operating in the multi-screen setup 230. The cursor monitoring agent 224 fetches the profiles from the boundary area profile database 216 prior to monitoring movement of the cursor 250 in the boundary area 260 of a session. The profiles are fetched when the sessions are launched.

The cursor analysis service 214 is in communications with the cursor monitoring agent 224. The cursor analysis service 214 receives cursor movement data from the cursor monitoring agent 224 when the cursor 250 is in the boundary area 260. The cursor analysis service 214 is configured to analyze movement of the cursor 250 within the boundary area 260 to determine if one of the movement parameters is met indicating that a user intends to switch to a different session.

A display options menu command is generated by the cursor analysis service 214 in response to one of the movement parameters being met. The display options menu command is received by the cursor monitor service 214 which in turns causes the options menu 236 to be displayed.

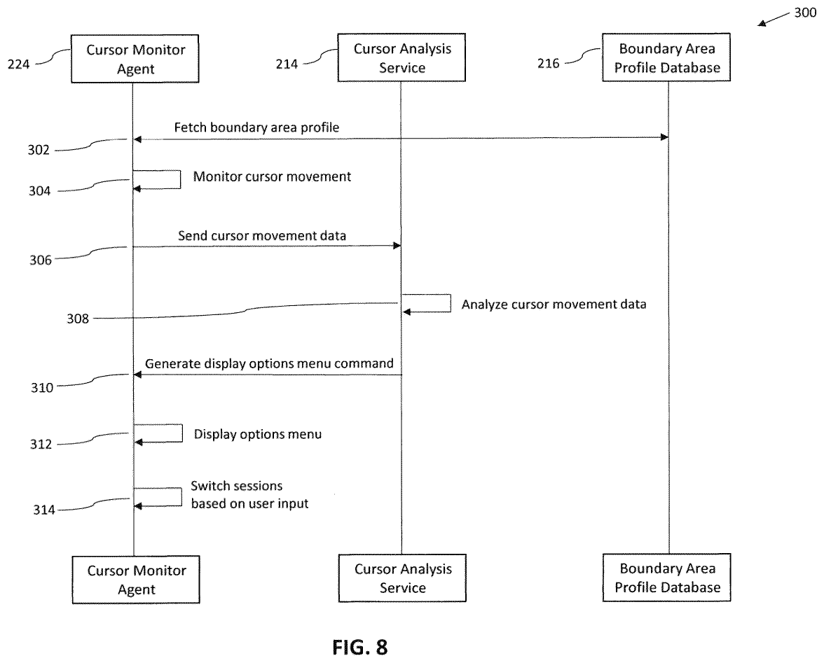

Referring now to FIG. 8, a sequence flow diagram 300 on operation of the computing system 200 will be discussed. In particular, the sequence flow diagram 300 shows how the cursor monitor agent 224, the cursor analysis service 214 and the boundary area profile database 216 interface with one another to detect and analyze cursor movement in a multi-screen setup 230 so as to assist a user in switching sessions.

A profile of the boundary area 260 for each session in the multi-screen setup 230 is fetched from the boundary area profile database 216 at line 302. Each profile defines the boundary area within a session where movement of the cursor 250 will be monitored and analyzed. The sessions could all use the same profile. Alternatively, one or more of the sessions could have a profile that is different from the other profiles.

The profiles may be default values. For example, a profile of a boundary area for each of the sessions may have a default value of 60 pixels. The 60 pixels defines a width of the boundary area 260 from each of the four edges of the session.

Monitoring and analyzing movement of the cursor 250 within the boundary area 260 is in addition to the monitoring of the cursor 250 that is already performed for display of the tool bar. As noted above, the tool bar is displayed when the cursor 250 is near the top edge of the session and the user selects a button on the input device 226. The pixel width monitored for display of the tool bar is limited to the top edge of each session, and typically has a width of 30 pixels.

The larger pixel width of the boundary area 260 helps to avoid unwanted behavior when the cursor 250 is too close to an edge of the session. The larger pixel width of the boundary area 260 provides additional space for the user to position the cursor 250 in order to display the options menu 236 without getting to close to the edges.

For instance, the connection to an adjacent screen may be through the top edge of the session. This corresponds to the adjacent screen being above the screen with the cursor 250. When the session is in a full screen mode and the cursor 250 is moved too close to the top edge, the cursor may continue into the adjacent screen. A similar unwanted behavior may happen on the side edge of a session, where connection to an adjacent screen is through the side edge. When the session is in a full screen mode and the cursor 250 is moved too close to the side edge, the cursor may continue into the adjacent screen.

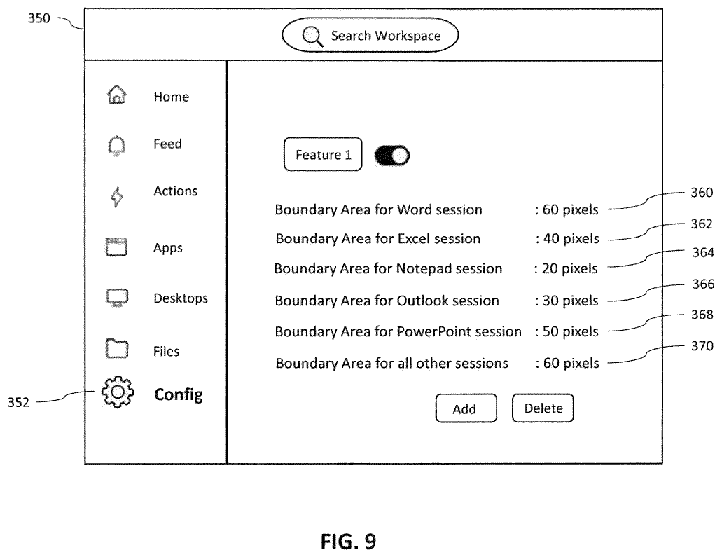

In lieu of using a default value for the boundary areas 260, the user may define the boundary areas 260. A screenshot 350 of the workspace user interface (UI) 350 for the client computing device 220 in shown in FIG. 9. After selecting the config tab 352, the user is able to individually select the profiles of the boundary areas 260 for the different sessions that may be displayed.

As examples, the user may set the boundary area 260 for a Word session to 60 pixels at line 360. The user may set the boundary area 260 for an Excel session to 40 pixels at line 362. The user may set the boundary area 260 for a Notepad session to 20 pixels at line 364. The user may set the boundary area 260 for an Outlook session to 30 pixels at line 366. The user may set the boundary area 260 for a PowerPoint session to 50 pixels at line 368. The user may set the boundary area 260 for all other sessions to 60 pixels at line 370. Other types of sessions may be added, or existing sessions that are listed may be deleted.

The set profile of a boundary area 260 will be scaled down when a session is in the windows mode. For example, a boundary area 260 of 60 pixels is for the session in the full screen mode. When the session is in the windows mode, the boundary area 260 will be adjusted based on a width of the screen and a width of the session. This corresponds to screen width/session width*60 pixels. Likewise, the boundary area 260 will be adjusted based on a height of the screen and a height of the session. This corresponds to screen height/session height*60 pixels.

After the cursor monitor agent 224 receives the boundary area profile, movement of the cursor 250 is monitored at line 304 by the cursor monitor agent 224. Application programming interface (API) of the workspace allows the cursor monitor agent 224 to receive coordinates of the cursor relative to the screen size for the full screen mode or relative to the session for the session mode.

For a Windows operating system a GetCursorPos function is used. For a Mac operating system an NSEvent mouseLocation function is used. Once the session is launched, the cursor monitor agent 224 is active and receives x, y coordinates on position of the cursor 250 relative to a size of the screen when in the full screen mode. Otherwise, the x, y coordinates would be relative to a size of the session in the windows mode.

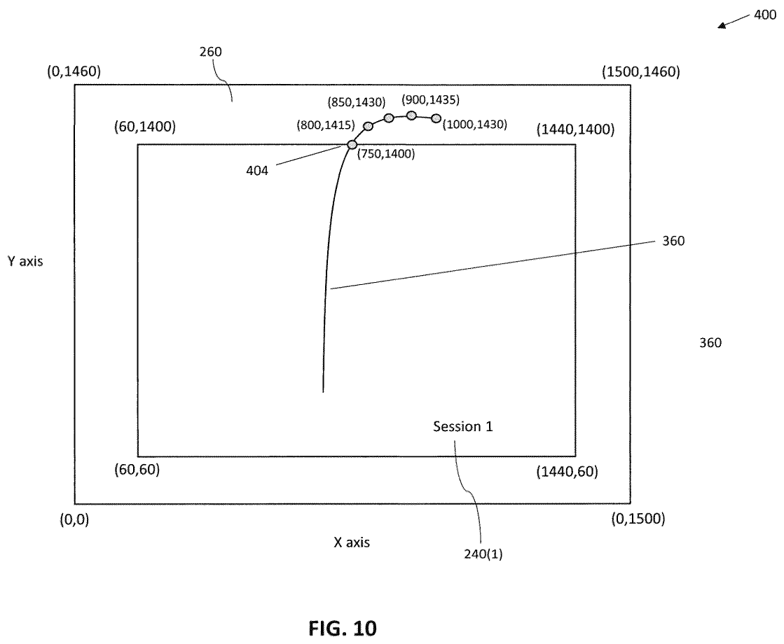

A graph 400 on cursor movement 402 is shown in FIG. 10. The screen size is 1500 pixels in width and 1460 pixel in height. With session 1 240(1) in the full screen mode, the boundary area 260 extends 60 pixels from the edges of the screen. The x, y coordinates are provided for each outside corner of the screen. Also, the x, y coordinates are provided for the each inside corner of the boundary area 260.

When the cursor 250 is outside of the boundary area 260, no action is taken by the cursor monitor agent 224. Once the x, y coordinates indicate that the cursor 250 is entering the boundary area 260, the cursor movement data is sent by the cursor monitor agent 224 to the cursor analysis service 214 at line 306. In this example, once the cursor is at point 404 on the graph, cursor movement data is passed to the cursor analysis service 214 since the cursor 250 is entering the boundary area 260. As the cursor continues to move in the boundary area 260, updated cursor movement data is sent to the cursor analysis service 214.

The cursor movement data in the boundary area 260 is analyzed by the cursor analysis service 214 at line 308. The cursor movement data is analyzed to determine if a movement parameter is met indicating that a user intends to switch to a different session.

As noted above, one of the movement parameters is based on velocity of the cursor 250 within the boundary area 260. The velocity of the cursor 250 may have a drop and the cursor 250 is still in the boundary area 260. Another parameter is based on continuous movement of the cursor 250 within the boundary area 260, where the user does not click any buttons on an input device 226 for a set time interval. The set time interval may be 2 to 3 seconds, for example.

Cursor movement and velocity of the cursor 250 are analyzed. The axial speed of cursor may be determined by the following equation:

$$Vcursor = \frac{fs}{rs} p$$

The variable fs is screen refresh frequency, the variable rs is screen resolution in dots per inch (dpi), and the variable p is displacement in pixels. The velocity V is in inches per second.

For example, fs=75 Hz and rs=112 dpi for a 1500, 1460 display having a length of 24 inches. If p=3 pixels/second, then the velocity V of the cursor 250 2 inches/second. As another example, if p=0.03 pixels/second, then the velocity V of the cursor 250 0.02 inches/second.

The time interval for p in the equation is 0.01 seconds. The cursor movement data received by the cursor analysis service 214 may be as follows:

$$Data 1 = \{ x = 750.00 , y = 1400.00 \} at time t = T 1 \\ Data 2 = \{ x = 750.03 , y = 1400.05 \} at time t = T 1 + 0.01 s \\ Data 3 = \{ x = 750.05 , y = 1400.08 \} at time t = T 1 + 0.02 s$$

In response to one of the movement parameters being met, the cursor analysis service 214 generates a display options menu command at line 310. This command is sent to the cursor monitor agent 224. This causes the cursor monitor agent 224 to display the options menu 236 within the session having the cursor 250. The options menu 236 provides a show tool bar option, and a list of the other sessions that the user could switch to.

When the options menu 236 is displayed, the user has a set time interval to make a selection. The set time interval may be 10 seconds, for example. If the user does not make a selection from the options menu 236 within the set time interval, then the options menu 236 disappears. For the options menu 236 to reappear, the user would have to move the cursor 250 out of the boundary area 260 and then move the cursor 250 back into the boundary area 260 and meet one of the movement parameters.

If the user selects a session to switch to, then the cursor 250 will be moved to the selected session as indicated by line 314. This is based on the cursor monitor agent 224 using the CGDisplayMoveCursorToPoint function.

Prior to switching the cursor 250 to a different session, the cursor monitor agent 224 fetches the screen layout of the screen being switched to and the position of the session within the screen. After the cursor monitor agent 224 identifies the origin coordinates of the session being switched to, the CGDisplayMoveCursorToPoint function is used to position the cursor 250 at the center of the destination session.

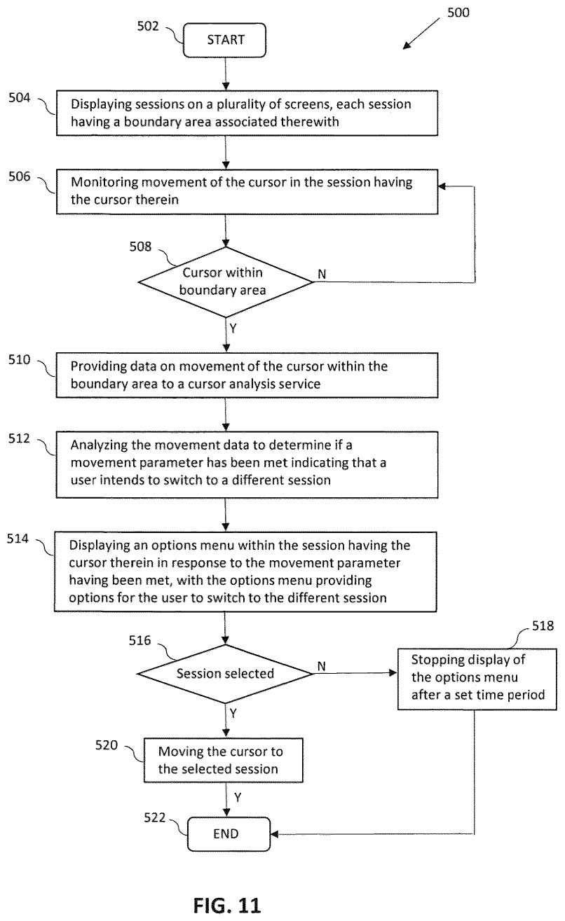

Referring now to FIG. 11, a flow diagram 500 for operating the above-described computing system 200 will be discussed. From the start (Block 502), a plurality of sessions 240(1)-240(4) are displayed on a plurality of screens 230(1)-230(4) at Block 504. Each session has a boundary area 260 associated therewith.

Movement of the cursor 250 in the session 240(1) having the cursor 250 therein is monitored using a cursor monitor agent 224 at Block 506. A determination is made at Block 508 on if the cursor 250 is positioned within the boundary area 260 of the session 240(1). If the cursor 250 is not in the boundary area 260, then the flow diagram loops back to Block 506.

If the cursor 250 is in the boundary area 260, then the data on movement of the cursor 250 within the boundary area 260 is provided at Block 510 to a cursor analysis service 214. The cursor analysis service 214 analyzes the movement data at Block 512 to determine if a movement parameter has been met indicating that a user intends to switch to a different session.

An options menu 236 is displayed within the session 240(1) having the cursor 250 therein at Block 514 in response to the movement parameter having been met. The options menu 236 provides options for the user to switch to the different session.

A determination is made at Block 516 on if the session has been selected. If the session has not been selected, then the options menu 236 stops being displayed after a set time period at Block 518. If the session has not been selected, then the cursor 250 is moved to the selected session at Block 520. The method ends at Block 522.

Furthermore, other aspects of the computing system and the client computing devices may take the form of a computer program product stored by one or more computer-readable storage media having computer-readable program code, or instructions, embodied in or on the storage media, for operation thereof. Any suitable computer readable storage media may be utilized, including hard disks, CD-ROMs, optical storage devices, magnetic storage devices, and/or any combination thereof.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A computing system comprising:
a client computing device comprising:
a plurality of screens, with each screen having at least one session displayed therein, and with each session having a boundary area associated therewith;
a processor coupled to said plurality of screens;
an input device coupled to said processor and configured to control movement of a cursor on said plurality of screens;
a cursor monitor agent to be executed by said processor to monitor movement of the cursor in the boundary area of the session having the cursor therein; and
a cloud management platform to be accessed by said client computing device, and comprising a cursor analysis service in communications with said cursor monitor agent, with the cursor analysis service configured to analyze movement of the cursor within the boundary area to determine if a movement parameter is met indicating that a user intends to switch to a different session;
wherein the cursor monitor agent is configured to display an options menu within the session having the cursor therein in response to the movement parameter having been met, with the options menu providing options for the user to switch to the different session.

2. The computing system of claim 1 wherein the options menu provides a list of the other sessions the user could switch to, with selection of the session being made using said input device.

3. The computing system of claim 2 wherein in response to the user selecting the session to switch to, said cursor monitor agent is configured to move the cursor to the selected session.

4. The computing system of claim 3 wherein said cursor monitor agent is configured to move the cursor to the selected session based on the following:
fetch a layout of the screen having the selected session, and position of the selected session within the screen;
identify origin coordinates of the selected session being switched to; and
execute a function command to position the cursor at a center of the selected session.

5. The computing system of claim 1 wherein said cursor monitor agent is further configured to stop display of the options menu in response to the user not selecting one of the displayed options within a set time period.

6. The computing system of claim 5 wherein for the options menu to reappear, the cursor is moved out of the boundary area and then moved back into the boundary area, and said cursor analysis service analyzes movement of the cursor within the boundary area to determine that the movement parameter has been met.

7. The computing system of claim 1 wherein the options menu provides a show tool bar option, and wherein said cursor monitor agent is further configured to display a tool bar in response to the user selecting the tool bar option using said input device.

8. The computing system of claim 1 wherein said cursor analysis service is configured to determine one of the movement parameters based on determining a drop in velocity of the cursor while the cursor is still in the boundary area.

9. The computing system of claim 1 wherein said cursor analysis service is configured to determine one of the movement parameters based on determining continuous movement of the cursor within the boundary area for a set time interval without any buttons being pressed on said input device.

10. The computing system of claim 1 wherein said cloud management platform comprises a boundary area profile database, and wherein in response to the sessions being launched, said cursor monitor agent fetches the boundary area profiles corresponding to the launched sessions.

11. A client computing device comprising:
a plurality of screens, with each screen having at least one session displayed therein, and with each session having a boundary area associated therewith;
a processor coupled to said plurality of screens;
an input device coupled to said processor and configured to control movement of a cursor on said plurality of screens; and
a cursor monitor agent to be executed by said processor to perform the following:
monitor movement of the cursor in the session having the cursor therein,
provide data on movement of the cursor within the boundary area to a cursor analysis service for the cursor analysis service to determine if a movement parameter has been met indicating that a user intends to switch to a different session, and
display an options menu within the session having the cursor therein in response to the movement parameter having been met, with the options menu providing options for the user to switch to the different session.

12. The client computing device of claim 11 wherein the options menu provides a list of the other sessions the user could switch to, with selection of the session being made using said input device.

13. The client computing device of claim 12 wherein in response to the user selecting the session to switch to, said cursor monitor agent is configured to move the cursor to the selected session.

14. The client computing device of claim 13 wherein said cursor monitor agent is configured to move the cursor to the selected session based on the following:
fetch a layout of the screen having the selected session, and position of the selected session within the screen;
identify origin coordinates of the selected session being switched to; and
execute a function command to position the cursor at a center of the selected session.

15. The client computing device of claim 11 wherein said cursor monitor agent is further configured to stop display of the options menu in response to the user not selecting one of the displayed options within a set time period.

16. The client computing device of claim 15 wherein for the options menu to reappear, the cursor is moved out of the boundary area and then moved back into the boundary area, and said cursor analysis service analyzes movement of the cursor within the boundary area to determine that the movement parameter has been met.

17. The client computing device of claim 11 wherein the options menu provides a show tool bar option, and wherein said cursor monitor agent is further configured to display a tool bar in response to the user selecting the tool bar option using said input device.

18. A method computing comprising:
displaying a plurality of sessions on a plurality of screens, with each screen having at least one session displayed therein, and with each session having a boundary area associated therewith;
monitoring movement of the cursor in the session having the cursor therein using a cursor monitor agent;
providing data on movement of the cursor within the boundary area to a cursor analysis service for the cursor analysis service to determine if a movement parameter has been met indicating that a user intends to switch to a different session; and
displaying an options menu within the session having the cursor therein in response to the movement parameter having been met, with the options menu providing options for the user to switch to the different session.

19. The method of claim 18 wherein the options menu provides a list of the other sessions the user could switch to, with selection of the session being made using said input device.

20. The method of claim 19 wherein in response to the user selecting the session to switch to, the cursor monitor agent is configured to move the cursor to the selected session.
